(19) United States
(12) Patent Application Publication
(10) Pub. No.: US 2013/0282270 A1
(43) Pub. Date: Oct. 24, 2013

(54) Method and Device for Compressing Route Data

(71) Applicant: Bayerische Motorn Werke Aktiengesellschaft, Muenchen (DE)

(72) Inventors: Marcello TAVA, Muenchen (DE); Stefan FEIT, Muenchen (DE)

(21) Appl. No.: 13/919,614

(22) Filed: Jun. 17, 2013

Related U.S. Application Data
(63) Continuation of application No. PCT/EP2011/071370, filed on Nov. 30, 2011.

(30) Foreign Application Priority Data
Dec. 17, 2010 (DE) 10 2010 063 330.5

(51) Int. Cl. G01C 21/34

(52) U.S. Cl. CPC G01C 21/34
USPC 701/400

(57) ABSTRACT

A method and device for compressing route data are provided. A predefined route which includes a plurality of route elements characterizing the route is made available. Depending on a predefined division parameter, the predefined route is divided into partial routes. With respect to the partial routes, those route elements which are required to reconstruct the partial route by way of a route calculation on the basis of optimization of a predefined quality criterion are determined as compressed route elements. The compressed route elements of the component routes are assigned to a compressed route.

### CROSS REFERENCE TO RELATED APPLICATIONS

This application is a continuation of PCT International Application No. PCT/EP2011/071370, filed Nov. 30, 2011, which claims priority under 35 U.S.C. §119 from German Patent Application No. DE 10 2010 063 330.5, filed Dec. 17, 2010, the entire disclosures of which are herein expressly incorporated by reference.

### BACKGROUND AND SUMMARY OF THE INVENTION

The invention relates to a method and a device for the compression of route data.

Navigation devices are commonly included in modern motor vehicles. Such devices enable the determination of a route between a starting point and a destination point, as well as provide route guidance to the destination point. The route guidance incorporates an updated position which is commonly determined by means of a GPS system.

More and more frequently, navigation devices are also equipped with a communication interface, which enables a communication with an external computer device. In this case, the communication is carried out via a mobile radio interface and a corresponding mobile radio network, for example, which can also be connected to the internet. Such a navigation system, which also includes an external computer device along with the navigation device and the communication interface which is functionally assigned to the same, enables the transmission of a prespecified route, for example, to the navigation device, said route being represented by route elements, wherein the route is then used for the purpose of route guidance. For the purpose of making the transmission of the required information pertaining to the route as efficient as possible, a data reduction is performed on multiple route elements which characterize the route as clearly as possible. Each of these route elements can then be used in the navigation device for the purpose of reconstructing the route, and for route guidance from the starting point to the prespecified destination.

The problem addressed by the invention is that of creating a method and a device for the compression of route data, which enable an efficient compression.

The invention is characterized by a method and a corresponding device for the compression of route data. A prespecified route is made available which includes multiple route elements which characterize the route. The route can be made available, for example, in such a manner that it is received via a communication interface and/or is queried from a data storage device.

Depending on a prespecified division parameter, the route being compressed is divided into partial routes. For each partial route, the specific route elements which are required for a reconstruction of each partial route by means of a route calculation based on an optimization of a prespecified quality criterion are determined as the compressed route elements. The compressed route elements of the partial routes are functionally assigned to a compressed route.

The foregoing is based on the recognition that it is frequently possible to determine the compressed route with significantly reduced calculating complexity by dividing the prespecified route into partial routes, and therefore it is also possible to determine the compressed route more quickly. Moreover, the determination of each of the compressed route elements pertaining to each of the partial routes can optionally be carried out in parallel.

In this manner, it is possible to particularly achieve a very high increase in efficiency because the total complexity of the determination of the compressed route elements related to all of the partial routes is significantly less than the complexity of the determination of corresponding compressed route elements related directly to the prespecified route. This advantage makes a particularly significant contribution in the case of a long route, the same typically having a correspondingly large number of route elements, and also in cases with a significant deviation of the individual route elements of the prespecified route related to the specific route elements which are functionally assigned to the respective, optimized route from the same starting points and destination points, said route being optimized for the prespecified quality criterion.

The compressed route can be saved in a storage device, for example, and/or made available via a communication interface—for example of a navigation device, and particularly in a vehicle.

According to one advantageous embodiment, the quality criterion characterizes a route length. In this manner, it is possible to reconstruct the compressed route, particularly in a navigation device, in a particularly reliable manner, and notably independently of the design of the specific navigation device. This is because navigation devices typically possess the functionality to determine a route by way of optimization of the route length. This is particularly advantageous because the route length has an objective character which cannot be influenced by the driver-specific manner of driving—in contrast to the driving speed, for example.

If the quality criterion characterizes the length of the route, an optimization is preferably carried out to minimize the length of the route.

According to a further advantageous embodiment, the division parameter represents a prespecified maximum length of each of the partial routes. In this manner, it is particularly simple to determine the partial routes—specifically by dividing the prespecified routes in such a manner that each of the partial routes does not exceed the prespecified maximum length.

According to a further advantageous embodiment, the partial parameter is determined according to a local density of the street network around each of the partial routes being determined. In this manner, it is possible to exploit the fact that the local density of the street network is representative for the calculation complexity which can be expected for the determination of the compressed route elements which are assigned to each of the partial routes. As such, the prespecified route can be suitably divided into the partial routes for the purpose of minimizing the total calculation complexity.

According to a further advantageous embodiment, the division parameter is determined according to a street type in the proximity of each partial route being determined. This approach exploits the fact that the street type potentially has a high degree of influence on the resulting deviation of each of the partial segments of the prespecified route from the optimized route which will be established in this area upon optimization for the particular, prespecified quality criterion.

As such, by way of example, it is commonly the case that if a route changes to a prespecified type of street, a typical further profile of the route can be expected with a high degree of probability. By way of example, if a route proceeding from a certain route element follows a highway, and particularly an expressway, then it can be expected with a high degree of probability that the route will continue on this street type for a longer distance. As a consequence, the division parameter for such a route segment can be prespecified with an increased maximum length.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a general block diagram of a navigation system;

FIG. 2 is a flow diagram of an exemplary program used for the compression of route data; and

FIG. 3 shows an exemplary illustration of route elements.

### DETAILED DESCRIPTION OF THE DRAWINGS

Indices are noted in the reference numbers in the figures by underlining, wherein the following letter or the following number represents the respective index.

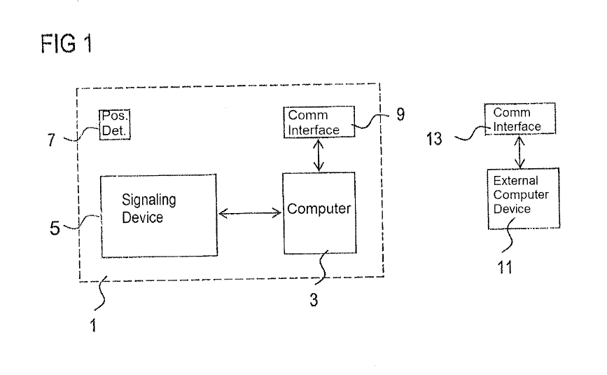

Referring to FIG. 1, a navigation system includes a navigation device 1. The navigation device 1 has a computer 3 which preferably has a data and program storage device and a processor. The processor is designed for the purpose of executing the programs saved in the data storage device, optionally incorporating data which is likewise saved in the storage device.

In addition, the navigation device 1 also has a signaling device 5, which can be designed as a visual and/or acoustic signaling device, by way of example.

Moreover, a position determining device 7 is functionally assigned to the navigation device 1, and can include a GPS receiver, for example. In addition, a communication interface 9 is functionally assigned to the navigation device 1. The communication interface 9 can include a mobile radio interface, by way of example. However, it can alternatively or additionally include a wired interface, for example, such as a USB interface. It can also further have any other communication interface 9, for example, such as a Bluetooth interface. By way of example, the navigation device 1 is arranged in a vehicle.

Moreover, the navigation system includes an external computer device 11 wherein a communication interface 13 is likewise directly or indirectly assigned to the same, and is designed to communicate with the communication interface 9 of the navigation device 1. The external computer device 11 can be designed as a so-called back-end server, for example, or as a server of a corresponding service provider, for example.

The external computer device 11 can also be characterized as a device for the compression of route data. Moreover, as an alternative or in addition thereto, the computer 3 of the navigation device can also have the functionality of the device which compresses the route data, and can be characterized as a device for the compression of route data.

The external computer device 11 has at least one computer, particularly comprising a processor, and one data and/or program storage device.

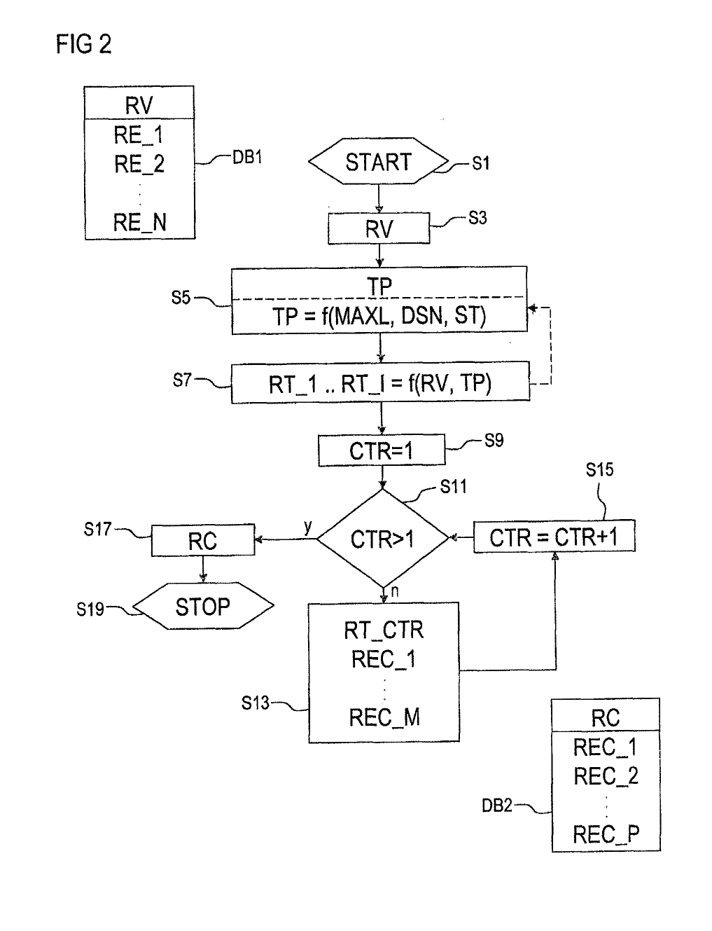

A program which is saved in the program storage device of the external computer device 11, and which is executed during the operation of the external computer device 11, is described in greater detail below with reference to FIG. 2.

The program is started in a step S1 (FIG. 2), in which variables or parameters are optionally initialized.

In a step S3, a prespecified route RV is provided, which includes multiple route elements RE characterizing the route. The prespecified route RV is provided, for example, by being calculated in the external computer device. The provision of the prespecified route RV can also be carried out by means of querying the same from the data storage device of the external computer device 11, for example.

The prespecified route RV includes multiple route elements RE that characterize the route, wherein N indicates the number of the route elements RE of the prespecified route RV. The route elements can include nodes and/or the connection elements between nodes, for example. The route elements RE assigned to the prespecified route RV are illustrated with the data block DB1 in FIG. 2.

In a step S5, a division parameter TP is determined. The division parameter can be defined in advance, and can represent a prespecified maximum length MAXL of each partial route RT, for example. As such, it can represent a length of approximately 15 km, for example. However, this value should only be seen as an example, and other values can be used.

Moreover, the division parameter TP can optionally be determined as a function of a local density DSN of the street network in the proximity of the respective partial route RT being determined. This is preferably carried out in such a manner that, given a higher local density DSN, the division parameter assumes a lower value—meaning that the prespecified maximum length MAXL is accordingly reduced, for example. In addition to a simple indication of length, the division parameter TP can, in principle, represent a maximum number of route elements which each of the partial routes should have as a maximum, for example.

The division parameter TP can also be optionally determined as a function of a street type ST in the proximity of each of the partial routes RT being determined. As such, it can assume different values according to the street type ST, as has already been explained above in the context of the highway street type, particularly the expressway. The division parameter TP can, in principle, be determined by means of any combination of the local density DSN, the street type ST, the maximum prespecified length MAXL and/or the maximum number of route elements per partial route RT.

In a step S7, each of the partial routes RT are then determined, wherein I represents the number of the partial routes RT. The determination of each of the partial routes RT is carried out according to the division parameter TP and the prespecified route RV. As such, each of the partial routes RT then includes a subset of the route elements RE of the prespecified route.

The division parameter TP can optionally also be determined again following any given number, such as one, of determined partial routes RT, such that in this case the process falls back to step S5.

In a step S9, a counter CTR is loaded with a start value, which can be one, for example.

In a step S11, a check is made as to whether the counter CTR has a value which is larger than the number I of the partial routes RT. If this is not the case, then the route elements RE which are required for a reconstruction of the respective partial route RT by means of a route calculation based on an optimization of a prespecified quality criterion are determined as compressed route elements REC, in a step S13, related to the partial route RT which is the specified partial route which corresponds to the counter CTR. The step S13 can optionally require an embedded iterative process.

By way of example, the quality criterion can characterize a route length. As such, in step S13, the specific route elements RE which are required for a reconstruction of this particular partial route RT by means of a route calculation based on an optimization of the route length—that is, particularly a minimization of the route length—are determined as compressed route elements REC.

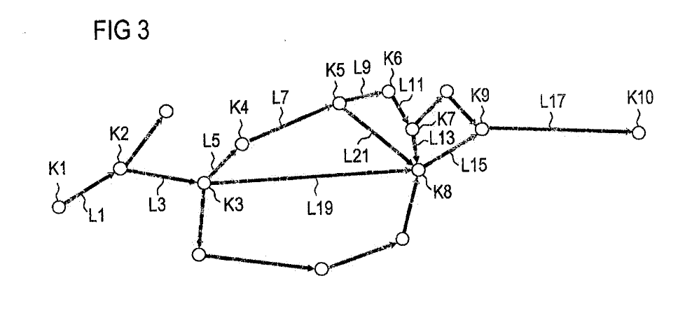

The process pertaining to this is described further below in greater detail with reference to FIG. 3. M indicates the number of the compressed route elements REC of each partial route RT.

In a step S15, the counter CTR is then advanced incrementally in a prespecified manner, for example by the value of one. Next, the processing in step S11 is continued.

If the condition of step S11 is met, then a compressed route RC is determined in a step S17, wherein the compressed route elements REC of the partial routes RT are functionally assigned to the compressed route RC. The compressed route RC is therefore suitable for the reconstruction of the prespecified route RV by way of a route calculation based on the optimization of the prespecified quality criterion. In principle, the compressed route RC includes a reduced number of compressed route elements compared to the number N of the route elements RE of the prespecified route. The number of the compressed route elements REC of the compressed route RC is indicated with P.

The compressed route is illustrated in FIG. 2 by the data block DB2. The compressed route RC is saved in the storage device of the external computer device 11, for example, and then can be made available at any time via the communication interface 13 of the external computer device 11, and for example transmitted to the communication interface 9 of the navigation device 1. The navigation device 1 is preferably designed for the purpose of accordingly reconstructing the prespecified route RV from the compressed route RC. In a step S19, the program is ended.

Various different route elements RE are illustrated in FIG. 3, which represent a prespecified segment of a street network. In this case, the route elements RE in FIG. 3 include the nodes K1 to K10 and links L1 to L21, each representing a connection between two neighboring nodes K1 to K10.

The prespecified route RV is characterized by the route elements RE. By way of example, the route elements RE can be the nodes K1, K2, K3, K4, K5, K6, K7, K8, K9, and K10, which are assigned to the prespecified route RV. In this case, node K1 is a start node, and node K10 is a destination node. As an alternative, the route elements which are assigned to the prespecified route RV can also be the corresponding connection elements L1, L3, L5, L7, L9, L11, L13, L15, and L17.

In step S7 of the program according to FIG. 2, the prespecified route RV is divided into the partial routes RT. This has the result, by way of example, that a first partial route RT_{—}1 includes the nodes K1, K2, K3. In addition, a second partial route RT_{—}2 includes the nodes K3, K4, K5, K6, K7, and K8. In addition, a third partial route RT_{—}3 has the nodes K8, K9, and K10.

The determination of the compressed route elements REC using the quality criterion of the length of the route is explained below. The route elements which pertain to the first partial route RT_{—}1 and characterize the path of the shortest route between the nodes K1 and K3 are the route elements K1, K2, and K3. As such, only nodes K1 and K3 need to be assigned to the first partial route RT_1 as compressed route elements REC for the purpose of reconstructing the first partial route RT_{—}1.

With respect to the second partial route RT_{—}2, the shortest route runs between the nodes K3 and K8 via the connection element L19. In any case, the second partial route RT_{—}2 deviates therefrom, such that the shortest route between the nodes K3 and K8 is determined by incorporating the node K4. The shortest route between the nodes K3 and K8, as determined using the node K4, includes both node K4 and node K5, which is then connected to the node K8 via the connection element L21. However, this does not represent the second partial route RT_{—}2, such that the shortest route between the nodes K3 and K8 is determined in a further step with the inclusion of the nodes K4, K5, and K6. The shortest route determined in this manner includes the points K3, K4, K5, K6, K7, and K8, which correspond to the partial route RT_{—}2. As such, the nodes K3, K4, K6, and K8 are assigned as compressed route elements REC to the second partial route RT_{—}2.

With respect to the third partial route RT_{—}3, the shortest route has the nodes K8, K9, and K10. This corresponds to the nodes of the third partial route RT_{—}3. As such, the nodes K8 and K10 are assigned to the third partial route RT_{—}3.

The compressed route RC then includes the compressed route elements REC, and particularly the nodes K1, K3, K4, K6, K8 and K10.

The complexity of calculation required for the determination of the compressed route elements of the partial routes RT_{—}1, RT_{—}2, RT_{—}3 is typically significantly lower than the calculation complexity which must be used in a case where the determination of the compressed route elements would take place without the division of the prespecified route RV.

### LIST OF REFERENCE NUMBERS

1 navigation device

3 computer

5 signaling device

7 position determination device

9 communication interface

11 external computer device

13 communication interface

RV prespecified route

RE route element

N number of the route elements of the prespecified route

TP division parameter

MAXL prespecified maximum length

DSN local density of the street network

ST street type

RT partial route

I number of the partial routes

CTR counter

REC compressed route element

M number of the compressed route elements of the respective partial route

RC compressed route

P number of the compressed route elements of the compressed route

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for compressing route data in a navigation system, the method comprising the acts of:
providing a prespecified route comprising multiple route elements characterizing the route;
dividing the prespecified route into partial routes in accordance with a prespecified division parameter;
with respect to each of the partial routes, determining specific route elements, as compressed route elements, that are required to reconstruct the partial route, via a route calculation based on optimization of a prespecified quality criterion; and
assigning the compressed route elements of the partial routes to a compressed route.

2. The method according to claim 1, wherein the prespecified quality criterion is a function of route length.

3. The method according to claim 2, wherein the prespecified division parameter represents a prespecified maximum length of the respective partial route.

4. The method according to claim 1, wherein the prespecified division parameter represents a prespecified maximum length of the respective partial route.

5. The method according to claim 3, wherein the prespecified division parameter is determined according to a local density of a street network in proximity of the respective partial route being determined.

6. The method according to claim 1, wherein the prespecified division parameter is determined according to a local density of a street network in proximity of the respective partial route being determined.

7. The method according to claim 5, wherein the prespecified division parameter is determined as a function of a street type in proximity of the respective partial route being determined.

8. The method according to claim 3, wherein the prespecified division parameter is determined as a function of a street type in proximity of the respective partial route being determined.

9. The method according to claim 1, wherein the prespecified division parameter is determined as a function of a street type in proximity of the respective partial route being determined.

10. A device for compressing route data in a navigation system, the device comprising:
a computer having a computer readable medium containing program code segments that:
make a prespecified route available, said route including multiple route elements characterizing the route;
divide the prespecified route into partial routes as a function of a prespecified division parameter;
for each partial route, determine specific route elements, as compressed route elements, that are required for reconstructing the respective partial route, by way of a route calculation based on an optimization of a prespecified quality criterion; and
assign the compressed route elements of the partial routes to a compressed route.
